(19) United States
(12) Patent Application Publication
(10) Pub. No.: US 2026/0048963 A1
(43) Pub. Date: Feb. 19, 2026

(54) DOUBLE GUIDE RAIL AND ELEVATOR ASSEMBLY

(71) Applicant: Otis Elevator Company, Farmington, CT (US)

(72) Inventors: Salvador Garcia, Leganés (ES); Enrique Alvarez Berzal, Leganés (ES); Marcos García González, Madrid (ES); Oscar Vila, Leganés (ES); Marcos Marra, Leganés (ES); Agustin Jimenez, Alcorcon (ES); Eduardo David Ramirez, Leganés (ES)

(21) Appl. No.: 19/297,274

(22) Filed: Aug. 12, 2025

(30) Foreign Application Priority Data
Aug. 14, 2024 (EP) 24382908.2

(51) Int. Cl. B66B 7/02

(52) U.S. Cl. CPC B66B 7/022

(57) ABSTRACT

A guide rail (1) for guiding an elevator car (2) and a counterweight (3) during their up and down movements. The guide rail (1) includes a first guiding portion (4) for guiding the elevator car (2) and a second guiding portion (5) being integrally formed with the first guiding portion (4) for guiding the counterweight (3). Each guiding portion (4, 5) further forms a base section (6, 7) configured for being connected directly or indirectly to a part of a building (8) and a rail section (9, 10) protruding from the base section (6, 7). Each guiding portion (4, 5) is T-shaped in cross-section.

### FOREIGN PRIORITY

This application claims priority to European Patent Application No. 24382908.2, filed Aug. 14, 2024, and all the benefits accruing therefrom under 35 U.S.C. § 119, the contents of which in its entirety are herein incorporated by reference.

### TECHNICAL FIELD OF INVENTION

The disclosure relates to a guide rail for guiding an elevator car and a counterweight during their up and down movements, as well as an elevator assembly having an elevator car, a counterweight and at least one guide rail, or alternatively two guide rails.

### BACKGROUND OF THE INVENTION

It is generally known to use variously designed guide rails to guide the corresponding movements of the elevator car and the corresponding counterweight. It has been shown that these guide rails can be relatively complex to construct and therefore to manufacture. In particular, the need to use safety devices on the elevator car and counterweight results in additional space restrictions. At the same time, the strength requirements for these guide rails increase.

In this respect, it is an object of the present disclosure to provide an improved guide rail where the known disadvantages of the prior art are avoided.

This is solved by a guide rail and an elevator assembly according to the independent claims. Alternative embodiments are subject matter of the dependent claims.

### SUMMARY OF THE INVENTION

According to an aspect a guide rail for guiding an elevator car and a counterweight during their up and down movements is provided. Both the elevator car and the corresponding counterweight can contain safety devices that serve to block a relative movement between themselves and the guide rail (depending on a certain speed/acceleration). The guide rail comprises a first guiding portion for guiding the elevator car and a second guiding portion being integrally formed with the first guiding portion and for guiding the counterweight. Each guiding portion may form a base section (also referred to as base plate section) configured for being connected/attached directly or indirectly to a part of a building, like a wall (of a hoistway) or a girder. Furthermore, each guiding portion may form a rail section protruding from the base section, which may directly form a guide rail or a guide track for a rolling element (of the elevator car or the counterweight). Each guiding portion is T-shaped in cross-section. This enables a guide rail that is as rigid as possible, especially against bending loads which usually occur during the up and down movement of the elevator car and the counterweight. Moreover, the T-shape of the rail sections designed for guidance allows safety devices to be integrated directly between the elevator car or the counterweight on the one hand and the guide rail on the other, thus saving installation space. The structure of the guide rail can therefore be significantly simplified. Thus, the guide rail is as simple as possible to manufacture and, at the same time, more rigid against bending moments.

According to an aspect the two guiding portions are formed integrally with each other from one (single) metal sheet. The metal sheet can be a metal sheet, such as sheet steel, that has been folded or bent several times. This makes the guide rail easy to manufacture.

According to an aspect the rail sections of the two guiding portions are parallel to each other. This allows an even more space-saving arrangement of the elevator car and the counterweight.

According to an aspect the rail sections of the two guiding portions take up most of the height of their guiding portions. This further optimizes the cross-section of the guide rail with regard to the mass moment of inertia.

According to an aspect the rail sections of the two guiding portions have the same height or the height of these two rail sections differ by less than 10 percent from each other. This further optimizes the cross-section of the guide rail with regard to the mass moment of inertia.

According to an aspect the rail sections of the two guiding portions are formed by two metal sheet layers. This ensures a simple structure, but at the same time a structure that is as rigid as possible against bending.

According to an aspect the base sections of the two guiding portions are parallel to each other or are lying in a common plane. This also enables a compact design of the guide rail and its space-saving integration in the application area.

According to an aspect the base sections of the two guiding portions are formed by two metal sheet layers. This ensures a simple structure, but at the same time a structure that is as rigid as possible against bending also with regard to the base sections.

According to an aspect the first guiding portion and the second guiding portion are connected at their base sections via a common metal sheet layer. This makes the guide rail easy to manufacture.

According to an aspect a first plate area of the first guiding portion which is connected to a side of the rail section facing away from the second guiding portion is shorter than a second plate area of the first guiding portion facing the second guiding portion. This further improves the rigidity of the guide rail.

According to an aspect a first plate area of the second guiding portion which is connected to a side of the rail section facing away from the first guiding portion is shorter than a second plate area of the second guiding portion facing the first guiding portion. This also improves the rigidity of the guide rail.

According to an aspect the rail section of each guiding portion is integrally formed with a top metal sheet layer of the base section of the same guiding portion. This enables an easy-to-manufacture structure.

According to an aspect an elevator assembly is provided that comprises an elevator car, a counterweight for being motion coupled with the elevator car and at least a guide rail according to any one of the aforementioned aspects for guiding the elevator car and the counterweight during movement.

In other words, the present disclosure consists in a guide rail profile of a T-profile. A guide rail nose of the counterweight may be extended in order to meet the requirements to counterweight with safety devices using just one pair of guides.

The T profile improves the distance between guide rail brackets (better inertia in the weak axis) and the extension of the counterweight nose allows the safety device to operate in the counterweight guide rail avoiding the use of the solid extra guide. Both improvements have a crucial impact on the cost of the system for an elevator system. In addition, the new guide rail profile allows to have less space to install the elevator system.

### BRIEF DESCRIPTION OF THE DRAWINGS

Embodiments of the present disclosure, as an example only, will be described in the following with reference to the drawings. In the drawings:

FIG. 1 shows a cross-section view of a guide rail with two rail sections for guiding an elevator car and a counterweight; and

FIG. 2 shows a top view of an elevator assembly comprising two guide rails according to FIG. 1 and an elevator car as well as a counterweight which are in interaction with the guide rails.

### DETAILED DESCRIPTION OF THE INVENTION

In the following, embodiments of the present disclosure are explained with reference to the drawings. The same elements are assigned with the same reference numbers in the drawings. It is to be noted, that the embodiments are described for exemplary purposes only and the description of the embodiments is not intended to limit the scope of the present disclosure.

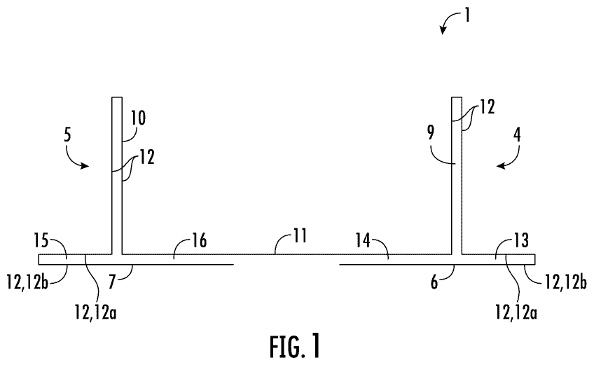

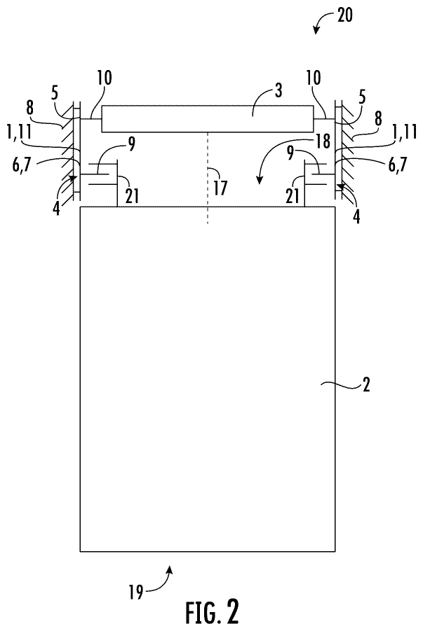

FIG. 1 shows the structure of a guide rail 1. The area of application of that guide rail 1 is indicated in FIG. 2. The guide rail 1 is used in an elevator assembly 20 to form an elevator system.

The guide rail 1 is used in operation to guide an elevator car 2 and an associated counterweight 3 during their up and down movement in the hoistway. In an embodiment, two guide rails 1 spaced apart from each other are used for guiding the elevator car 2 and the counterweight 3. Furthermore, elevator car 2 and counterweight 3 are coupled to each other in the usual manner, for example via a schematically indicated tension member 17.

It can also be seen that the elevator car 2 can be provided as cantilever-type. The elevator car 2 thus may be provided as a panoramic model in which at least two, in this case even three, adjacent sides are transparent and must therefore not be covered by parts of the building or of the elevator construction that obstruct the view. As can be seen in the top view of the elevator car 2 in FIG. 2, the guide rails 1 used to guide the elevator car 2 are located on the rear side 18 of the elevator car 2. The counterweight 3 coupled to the elevator car 2 is also located on the rear side 18, where it is guided by the guide rails 1, as well.

On the rear side 18 of the elevator car 2, two uprights 21 are shown that are attached on the rear side 18 of the elevator car 2, namely firmly connected to a non shown frame of the elevator car 2. Each upright 21, which in turn is in the form of a rail, interacts with a first guiding portion 4 of each guide rail 1. In a conventional manner, roller bodies are also inserted between the upright 21 and the guide rail 1/first guiding portion 4, which roll along the guide rail 1 during the up and down movement of the elevator car 2. A safety device can also be provided on the upright 21, which safety device serves to block/brake the elevator car 2 relative to the guide rail 1 in the event of unintentional movement of the elevator car 2. This safety device (also called safety brake) may be installed between the upright 21 and the guide rail 1/first guiding portion 4.

The counterweight 3 is arranged and guided on each guide rail 1 in a similar way to the elevator car 2. The counterweight 3 interacts with a second guiding portion 5 of the guide rail 1. In a conventional manner, roller bodies are also inserted between the counterweight 3 and the guide rail 1/second guiding portion 5, which roll along the guide rail 1 during the up and down movement of the counterweight 3. A safety device can also be provided in this concern on the counterweight 3, which safety device serves to block/brake the counterweight 3 relative to the guide rail 1 in the event of unintentional movement of the counterweight 3. This safety device may be installed between the counterweight 3 and the guide rail 1/second guiding portion 5.

In FIG. 2 ultimately two guide rails 1 are used, arranged mirrored to each other, which are usually indirectly or directly connected to a building 8/a component fixed to the building 8, such as a steel girder or a building wall (of a hoistway), on their side facing away from the counterweight 3 and the uprights 21. The guide rails 1, whose longitudinal direction is thus parallel to the intended direction of movement of the elevator car 2, are fixed to the building 8 in the area of base sections 6, 7 of their guiding portions 4, 5 at fixing points at regular intervals along their length.

Furthermore, it can be seen that due to the relative arrangement of counterweight 3 and elevator car 2, the first guiding portion 4 serving to guide the elevator car 2 is arranged closer to the rear 18 of elevator car 2 than the second guiding portion 5 serving to guide the counterweight 3.

Finally, FIG. 1 shows a more detailed structure of the guide rail 1 used. It can be seen that the guide rail 1 is formed from a single piece of material, namely from a single (folded) metal sheet 11. The two guiding portions 4, 5 of the guide rail 1 are therefore realized as components formed integrally with one another. It can also be clearly seen in FIG. 1 that the guiding portions 4, 5 are essentially identical and therefore have a rail section 9, 10 in addition to a base section 6, 7.

A base section 6 of the first guiding portion 4 can run perpendicular to the rail section 9 of the first guiding portion 4. A base section 7 of the second guiding portion 5 can run perpendicular to the rail section 10 of the second guiding portion 5. The two base sections 6, 7 can be plate-shaped. The two base sections 6, 7 can also lie in a common plane, as shown in FIG. 1. Alternatively, however, the two base sections 6, 7 can also run in different planes, for example parallel to each other. As shown in FIG. 2, the two rail sections 9, 10 can be used directly to guide the elevator car 2 and the counterweight 3.

FIG. 1 also shows that the two rail sections 9, 10 can be of the same length (seen in cross-section; otherwise also referred to as height when the guide rail 1 is viewed as a whole). In particular, the free ends of the rail sections 9, 10, which are at a maximum distance from the base sections 6, 7, can be at the same height (i.e. a common plane that runs parallel to a plane of the respective base section 6, 7). However, it is also possible for the rail sections 9, 10 to have different lengths/heights, for example they can differ in length/height by less than 10%.

It can be seen that the guide rail 1 is largely multi-layered, namely two-layered, whereby the metal sheet layers are identified by the reference signs 12; 12a, 12b. The rail sections 9, 10 are completely realized with two metal sheet layers 12. The two base sections 6, 7 are also for the most part formed by two metal sheet layers 12.

In this respect, it can be seen in more detail that the rail section 9, 10 is arranged essentially centrally to the base section 6, 7 of the respective guiding portion 4, 5 when viewed in the transverse direction of the guide rail 1. On closer inspection, it can be seen that the rail section 9, 10 is formed directly from a top metal sheet layer 12a of the base section 6, 7 of the respective guiding portion 4, 5. A bottom metal sheet layer 12b of the base section 6, 7 of the respective guiding portion 4, 5, on the other hand, runs along/parallel to the common plane in which the two base sections 6, 7 are arranged.

The two T-shaped guiding portions 4, 5 are thus arranged next to each other and merge directly into each other. At least one metal sheet layer 12 of the two metal sheet layers 12 of the first base section 6 at the same time forms a metal sheet the top metal sheet layer 12a of the first base section 6 may be formed integral with the top metal sheet layer 12a of the second base section 7. The same can apply to the bottom metal sheet layers 12b of these base sections 6, 7. However, there may also be a gap between the bottom metal sheet layers 12b of these base sections 6, 7.

It should also be noted that it is possible in principle that a first plate area 13 of the first guiding portion 4/base section 6, which first plate area 13 is connected to a side of the rail section 9 facing away from the second guiding portion 5, is shorter than a second plate area 14 of the first guiding portion 4/base section 6 facing the second guiding portion 5. Vice versa a first plate area 15 of the second guiding portion 5/base section 7, which first plate area 15 is connected to a side of the rail section 10 facing away from the first guiding portion 4, is shorter than a second plate area 16 of the second guiding portion 5/base section 7 facing the first guiding portion 4.

What is claimed is:

1. A guide rail (1) for guiding an elevator car (2) and a counterweight (3) during their up and down movements, the guide rail (1) comprising:
a first guiding portion (4) for guiding the elevator car (2) and a second guiding portion (5) being integrally formed with the first guiding portion (4) for guiding the counterweight (3),
wherein each guiding portion (4, 5) forms a base section (6, 7) configured for being connected directly or indirectly to a part of a building (8) and a rail section (9, 10) protruding from the base section (6, 7),
characterized in that
each guiding portion (4, 5) is T-shaped in cross-section.

2. The guide rail (1) according to claim 1, characterized in that the two guiding portions (4, 5) are formed integrally from one metal sheet (11).

3. The guide rail (1) according to claim 1, characterized in that the rail sections (9, 10) of the two guiding portions (4, 5) are parallel to each other.

4. The guide rail (1) according to claim 1, characterized in that the rail sections (9, 10) of the two guiding portions (4, 5) take up most of the height of their guiding portions (4, 5).

5. The guide rail (1) according to claim 1, characterized in that the rail sections (9, 10) of the two guiding portions (4, 5) have the same height or the height of these two rail sections (9, 10) differ by less than 10 percent from each other.

6. The guide rail (1) according to claim 1, characterized in that the rail sections (9, 10) of the two guiding portions (4, 5) are formed by two metal sheet layers (12).

7. The guide rail (1) according to claim 1, characterized in that the base sections (6, 7) of the two guiding portions (4, 5) are parallel to each other or are lying in a common plane.

8. The guide rail (1) according to claim 1, characterized in that the base sections (6, 7) of the two guiding portions (4, 5) are formed by two metal sheet layers (12).

9. The guide rail (1) according to claim 1, characterized in that the first guiding portion (4) and the second guiding portion (5) are connected at their base sections (6, 7) via a common metal sheet layer (12).

10. The guide rail (1) according to claim 1, characterized in that a first plate area (13) of the first guiding portion (4) which is connected to a side of the rail section (9) facing away from the second guiding portion (5) is shorter than a second plate area (14) of the first guiding portion (4) facing the second guiding portion (5).

11. The guide rail (1) according to claim 1, characterized in that a first plate area (15) of the second guiding portion (5) which is connected to a side of the rail section (10) facing away from the first guiding portion (4) is shorter than a second plate area (16) of the second guiding portion (5) facing the first guiding portion (4).

12. The guide rail (1) according to claim 1, characterized in that the rail section (9, 10) of each guiding portion (4, 5) is integrally formed with a top metal sheet layer (12a) of the base section (6, 7) of the same guiding portion (4, 5).

13. An elevator assembly (20) comprising an elevator car (2), a counterweight (3) for being motion coupled with the elevator car (2) and at least one guide rail (1) according to claim 1 for guiding the elevator car (2) and the counterweight (3) during movement.
